(19) United States
(12) Patent Application Publication
(10) Pub. No.: US 2026/0051449 A1
(43) Pub. Date: Feb. 19, 2026

(54) CONTACT HOLDER, AUXILIARY CONTACT MODULE AND CONTACTOR

(71) Applicant: Xiamen Hongfa Electrical Safety & Controls Co., Ltd., Xiamen (CN)

(72) Inventors: Xiaoju JI, Xiamen (CN); Xieli ZHANG, Xiamen (CN); Yanxiong YU, Xiamen (CN)

(21) Appl. No.: 19/291,426

(22) Filed: Aug. 5, 2025

(30) Foreign Application Priority Data
Aug. 14, 2024 (CN) 202411113327X

(51) Int. Cl. H01H 50/54; H01H 50/04

(52) U.S. Cl. CPC H01H 50/541; H01H 50/045; H01H 50/546; H01H 2050/046; H01H 2205/014

(57) ABSTRACT

A contact holder applied to an auxiliary contact module of a contactor includes a holder body and a linkage member on the holder body. The holder body is provided with a groove corresponding to the linkage member, and the linkage member is of an elastically deformable structure, to allow the linkage member to retract and deform in a direction towards an interior of the groove when subjected to mounting pressure.

### CROSS-REFERENCE TO RELATED APPLICATIONS

This application claims the benefit of and priority to Chinese Patent Application No. 202411113327.X, filed on Aug. 14, 2024, the entire contents of which are incorporated herein by reference in its entirety.

### TECHNICAL FIELD

The present disclosure relates to the technical field of contactors and, more particularly, to a contact holder, an auxiliary contact module, and a contactor.

### BACKGROUND

There is currently an auxiliary contact module used in conjunction with an alternating current (AC) contactor. The auxiliary contact module includes a housing and a contact holder. The housing includes a front cover and a rear cover that snap together, and a sliding groove that may accommodate the contact holder is formed in the middle of the snap position between the front cover and the rear cover. At least one slot is provided at each of two sides of the sliding groove, and each slot is in communication with the sliding groove. An L-shaped piece with a shape suitable for the slot is provided in each slot, and each L-shaped piece is provided with a static contact at a side perpendicular to the sliding groove. The contact holder accommodated in the sliding groove is provided with a hollow portion in communication with the slots at the two sides. A bridge-type movable contact is provided in the hollow portion, a middle of the bridge-type movable contact is connected to an upper or lower side wall of the hollow portion through a spring, and two ends of the bridge-type movable contact protrude into the slots at the two sides and cooperate with the static contacts. A side surface of the contact holder in contact with the rear cover is provided with a protrusion (equivalent to a linkage member) protruding out of the housing, and a rectangular through-hole for upward and downward movement of the protrusion is provided in a corresponding position of the rear cover. When in use, the auxiliary contact module is fastened to a side wall of the AC contactor through a fastening member of the rear cover, so that the protrusion is inserted into a linkage socket of the AC contactor. When an armature and a yoke of the AC contactor are attracted to each other, the contact holder moves downwards, causing a first bridge-type movable contact to come into contact with a first pair of static contacts, and turning on a circuit connected at an external terminal, and causing a second bridge-type movable contact to move downwards away from a second pair of static contacts, and turning off a circuit connected at an external terminal. However, the protrusion in this technical solution is rigidly connected to the contact holder, which has poor elasticity and is not easy to bend or deform. Consequently, when the auxiliary contact module is assembled with a contactor body, the entire contact holder will undergo a significant deformation in case of being subjected to pressure from a mounting direction, and the contact holder will generate a significant rebound force in case that the protrusion enters the linkage socket inside the contactor, which may easily cause its contact bridge to topple sideways and lead to circuit abnormalities.

### SUMMARY

According to one aspect of the present disclosure, a contact holder applied to an auxiliary contact module of a contactor includes a holder body and a linkage member on the holder body. The holder body is provided with a groove corresponding to the linkage member, and the linkage member is of an elastically deformable structure, to allow the linkage member to retract and deform in a direction towards an interior of the groove when subjected to mounting pressure.

According to an embodiment of the present disclosure, the linkage member is configured to be connected to an acting member inside a contactor body, and the linkage member is of an elastically deformable structure capable of being bent, retracted and deformed in a mounting direction.

According to an embodiment of the present disclosure, the groove is located in a middle position of the holder body, and the linkage is connected to the holder body and disposed corresponding to the groove.

According to an embodiment of the present disclosure , the linkage member includes a linkage protrusion and an elastic connecting piece, and the linkage protrusion is elastically connected to the holder body through the elastic connecting piece and corresponds to the groove. In case that the linkage member is subjected to the mounting pressure, the linkage protrusion is driven to retract in the direction towards the interior of the groove of the holder body by bending deformation of the elastic connecting piece under force.

According to an embodiment of the present disclosure, one end of the elastic connecting piece is connected to the holder body, and another end of the elastic connecting piece is suspended, the elastic connecting piece corresponds to the groove; and the linkage protrusion is disposed at the suspended end of the elastic connecting piece.

According to an embodiment of the present disclosure, the elastic connecting piece has an elongated structure, with one end connected to an upper end of a side wall of the groove, and another end disposed in a suspended manner; and the elastic connecting piece is flush with a surface of the groove.

According to an embodiment of the present disclosure, the elastic connecting piece includes a middle platform portion, and each of two ends of the middle platform portion is connected to the holder body through a U-shaped bent portion and correspond to the groove; and the linkage protrusion is fixedly connected to the middle platform portion.

According to an embodiment of the present disclosure, an opening of each U-shaped bent portion is oriented towards a direction of a bottom surface of the groove, and a top of each U-shaped bent portion is slightly higher than the middle platform portion.

According to another aspect of present disclosure, an auxiliary contact module, including a housing, a contact holder movably disposed inside the housing, and an auxiliary contact assembly mounted on the contact holder. The contact holder is the above-mentioned contact holder, and the housing is provided with an elongated avoidance hole corresponding to the linkage member and configured for partial exposure of the linkage member.

According to another aspect of present disclosure, a contactor, including a contactor body and the above-mentioned auxiliary contact module. A positioning protrusion is provided in a middle of a lower end of the housing, a first snap is provided at each of two sides of an upper end of the housing, and a movable second snap is provided in a middle of the upper end. The auxiliary contact module and the contactor body are fixedly connected together by using a positioning fit between the first positioning protrusion and a side wall of the contactor body, as well as a snap fit between the first snap and the second snap and the side wall of the contactor body.

### BRIEF DESCRIPTION OF THE DRAWINGS

FIG. 1 is a perspective schematic view of a contact holder according to a first embodiment of the present disclosure.

FIG. 2 is a side view of the contact holder according to the first embodiment of the present disclosure.

FIG. 3 is a perspective schematic view of an auxiliary contact module according to the first embodiment of the present disclosure.

FIG. 4 is a structural sectional view of the auxiliary contact module according to the first embodiment of the present disclosure.

FIG. 5 is a perspective schematic view of a contactor according to the first embodiment of the present disclosure.

FIG. 6 is a perspective schematic view of a contact holder according to a second embodiment of the present disclosure.

FIG. 7 is a side view of the contact holder according to the second embodiment of the present disclosure.

### REFERENCE NUMERALS

1. holder body, 2. linkage member, 3. housing, 4. contactor body, 11. groove, 21. linkage protrusion, 22. elastic connecting piece, 31. elongated avoidance hole, 32. positioning protrusion, 33. first snap, 34. second snap, 221. middle platform portion, 222. U-shaped bent portion.

### DETAILED DESCRIPTION

The present disclosure will be further described in conjunction with the accompanying drawings and embodiments.

In the description of embodiments of the present disclosure, terms such as “upper,” “lower,” “front, “rear” “left,” “right,” “top,” “bottom,” “inner,” and “outer” are used to refer to the orientations or positions as then described or as shown in the drawings under discussion, and are only used for convenience and simplicity of the description of embodiments of the present disclosure, but do not indicate or imply that the device or element referred to must have a particular orientation or be constructed and operated in a particular orientation. Thus, these terms shall not be construed as limitation on the embodiments of the present disclosure.

### First Embodiment

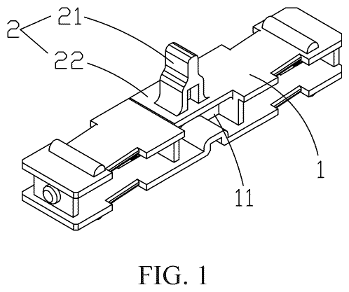

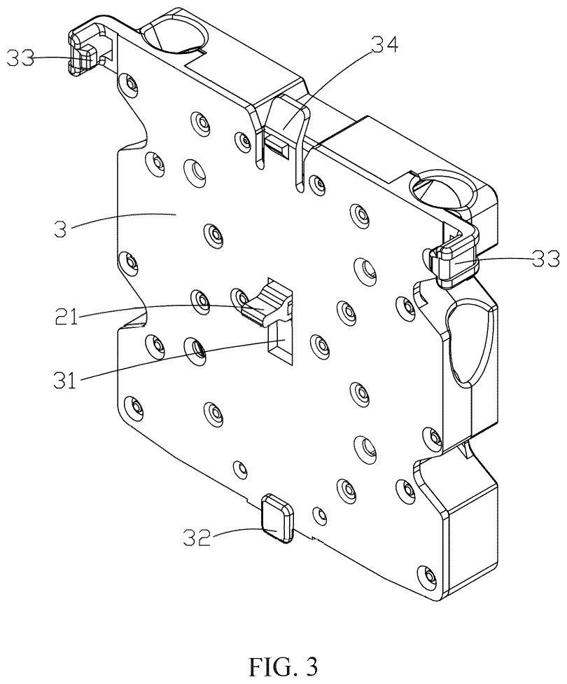

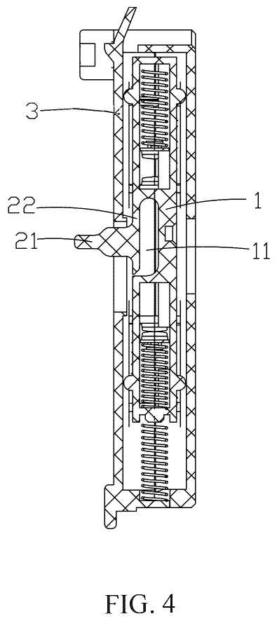

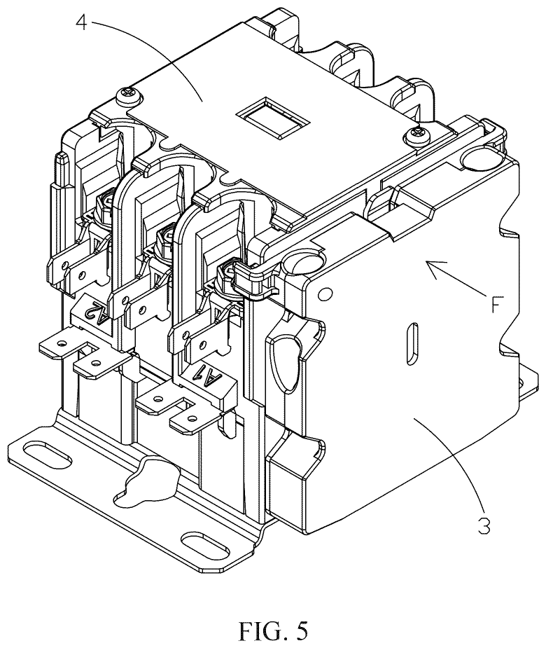

Referring to FIGS. 1 to 5, an embodiment of the present disclosure provides a contact holder applied to an auxiliary contact module of a contactor. The contact holder includes a holder body 1 and a linkage member 2 on the holder body 1. The holder body 1 is provided with a groove 11 corresponding to the linkage member 2, and the linkage member 2 is of an elastically deformable structure, so that when subjected to mounting pressure, the linkage member 2 may retract and deform in a direction towards an interior of the groove 11. It can be understood that in this embodiment, the linkage member 2 is of the elastically deformable structure, and the groove 11 is also provided on the holder body 1 to avoid the linkage member 2, so that during an assembly process of the auxiliary contact module and a contactor body, in case that the contact holder is subjected to the mounting pressure, the holder body 1 itself is not basically bent or deformed, and only the linkage member 2 undergoes bending deformation. As a result, after being assembled in place, only the linkage member 2 rebounds, and the holder body 1 does not basically rebound, so that a contact bridge mounted on the holder body 1 will not be affected and will not topple sideways, which in turn is conducive to improving the structural stability of the auxiliary contact module.

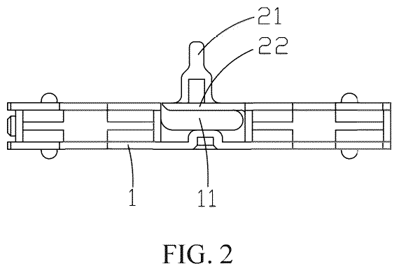

Referring to FIG. 1 and FIG. 2, in a preferred embodiment, the linkage member 2 is configured to be connected to an acting member inside the contactor body 4, and the linkage member 2 is of an elastically deformable structure that may be bent, retracted and deformed in a mounting direction. Preferably, the groove 11 is located in a middle position of the holder body 1, and the linkage member 2 is connected to the holder body 1 and disposed corresponding to the groove 11. However, those skilled in the art should understand that in other embodiments, the position of the linkage member 2 on the holder body 1 is not limited to the specific implementation disclosed in this embodiment, and those skilled in the art may set its connection position according to specific needs.

Referring to FIG. 1 and FIG. 2, in a preferred embodiment, the linkage member 2 includes a linkage protrusion 21 and an elastic connecting piece 22. The linkage protrusion 21 is elastically connected to the holder body 1 through the elastic connecting piece and corresponds to the groove 11. In case that the linkage member 2 is subjected to the mounting pressure, the bending deformation of the elastic connecting piece 22 under force drives the linkage protrusion 21 to retract in the direction towards the interior of the groove 11 of the holder body 1. Preferably, one end of the elastic connecting piece 22 is connected to the holder body 1, while the other end thereof is suspended and corresponds to the groove 11. The linkage protrusion 21 is disposed at the suspended end of the elastic connecting piece. According to an embodiment of the present disclosure, the elastic connecting piece 22 exhibits an elongated structure, with one end connected to an upper end of a side wall of the groove 11 and the other end disposed in a suspended manner, and the elastic connecting piece 22 is flush with a surface of the groove 11. It can be understood that in this embodiment, due to the variability performance of the linkage member 2, it is beneficial to reducing the mounting pressure during the assembly of the auxiliary contact module and the contactor body 4, which may be easily pressed downwards.

Referring to FIGS. 1 to 4, an embodiment of the present disclosure further provides an auxiliary contact module, including a housing 3, a contact holder movably disposed inside the housing 3, and an auxiliary contact assembly mounted on the contact holder. The contact holder is the above-mentioned contact holder, and the housing 3 is provided with an elongated avoidance hole 31 corresponding to the linkage member 2 and used for partial exposure of the linkage member 2.

Referring to FIGS. 1 to 5, an embodiment of the present disclosure further provides a contactor, including a contactor body 4 and the above-mentioned auxiliary contact module. A positioning protrusion 32 is provided in a middle of a lower end of the housing 3. A first snap 33 is provided at each of two sides of an upper end of the housing 3, and a second snap 34 is provided in a middle of the upper end. The auxiliary contact module and the contactor body 4 are fixedly connected together by using the positioning fit between the first positioning protrusion 32 and a side wall of the contactor body 4, as well as the snap fit between the first snap 33 and the second snap 34 and the side wall of the contactor body 4. In this embodiment, the side wall of the contactor body 4 is provided with a positioning slot hole corresponding to the positioning protrusion 32 and a snap-fit structure corresponding to the two first snaps 33 and the second snap 34. During installation, the auxiliary contact module is first slightly tilted, and then the positioning protrusion 32 is inserted into the positioning slot hole. Afterwards, the auxiliary contact module is lightly pressed to make the auxiliary contact module fit with the contactor body 4, and then the auxiliary contact module is pushed horizontally, to enter the linkage slot in the contactor body 4 by using the elastic bending and deformation ability of the linkage member. This assembly method is simple and fast, without need for tools, and saves time and labor with high efficiency.

### Second Embodiment

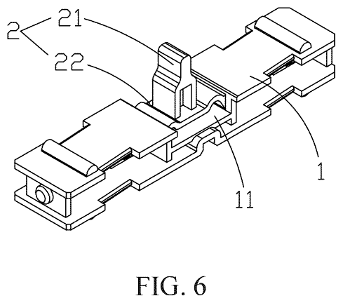

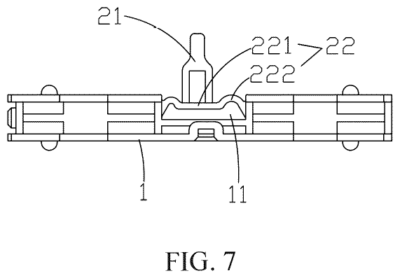

Referring to FIGS. 6 and 7, this embodiment differs from the first embodiment in the specific structure of the elastic connecting piece 22. Specifically, the elastic connecting piece 22 includes a middle platform portion 221, and each of two ends of the middle platform portion 221 is connected to the holder body 1 through a U-shaped bent portion 222 and corresponds to the groove 11. The linkage protrusion 21 is fixedly connected to the middle platform portion 221. Preferably, an opening of each U-shaped bent portion 222 is oriented towards a direction of a bottom surface of the groove 11, and a top of each U-shaped bent portion 222 is slightly higher than the middle platform portion 221. It can be understood that in this embodiment, the elastic connecting piece 22 is generally M-shaped. When the linkage member 2 is subjected to the mounting pressure, the M-shaped elastic connecting piece 22 may smoothly retract and deform towards the interior of the groove 11 without excessively skewing sideways. Compared to the elastic connecting piece 22 of the first embodiment, since the M-shaped elastic connecting piece 22 of this embodiment are connected to the holder body 1 at both sides, the linkage protrusion 21 may have better overall stability and higher strength, and the degree of deformation of the linkage protrusion 21 during an injection molding process of components may be smaller; the consistency of the components may be better; moreover, the degree of deformation during use may be lower.

The present disclosure has the following advantages or beneficial effects.

For the contact holder, the auxiliary contact module, and the contactor according to the present disclosure, the linkage member is of the elastically deformable structure, and the groove is also provided on the holder body to avoid the linkage member, so that during an assembly process of the auxiliary contact module and the contactor body, in case that the contact holder is subjected to the mounting pressure, the holder body itself is not basically bent or deformed, and only the linkage member undergoes bending deformation. As a result, after being assembled in place, only the linkage member rebounds, and the holder body does not basically rebound, so that a contact bridge mounted on the holder body will not be affected and will not topple sideways, which in turn is conducive to improving the structural stability of the auxiliary contact module.

The above embodiments are only used to illustrate rather than limit the technical solutions of the present disclosure. Although the present disclosure has been described in detail with reference to the aforementioned embodiments, those skilled in the art should understand that they may still modify the technical solutions described in the aforementioned embodiments, or equivalently substitute some of the technical features therein; these modifications or substitutions do not deviate the corresponding technical solutions from the spirit and scope of the technical solutions of the embodiments of the present disclosure. Therefore, all other embodiments obtained by those skilled in the art without creative effort fall into the protection scope of the present disclosure.

What is claimed is:

1. A contact holder, applied to an auxiliary contact module of a contactor, comprising a holder body (1) and a linkage member (2) on the holder body (1), wherein the holder body (1) is provided with a groove (11) corresponding to the linkage member (2), and the linkage member (2) is of an elastically deformable structure, to allow the linkage member (2) to retract and deform in a direction towards an interior of the groove (11) when subjected to a mounting pressure.

2. The contact holder according to claim 1, wherein the linkage member (2) is configured to be connected to an acting member inside a contactor body (4), and the linkage member (2) is of an elastically deformable structure capable of being bent, retracted and deformed in a mounting direction.

3. The contact holder according to claim 1, wherein the groove (11) is located in a middle position of the holder body (1), and the linkage (2) is connected to the holder body (1) and disposed corresponding to the groove (11).

4. The contact holder according to claim 1, wherein the linkage member (2) comprises a linkage protrusion (21) and an elastic connecting piece (22), and the linkage protrusion (21) is elastically connected to the holder body (1) through the elastic connecting piece and corresponds to the groove (11); in case that the linkage member (2) is subjected to the mounting pressure, the linkage protrusion (21) is driven to retract in the direction towards the interior of the groove (11) of the holder body (1) by bending deformation of the elastic connecting piece (22) under force.

5. The contact holder according to claim 2, wherein the linkage member (2) comprises a linkage protrusion (21) and an elastic connecting piece (22), and the linkage protrusion (21) is elastically connected to the holder body (1) through the elastic connecting piece and corresponds to the groove (11); in case that the linkage member (2) is subjected to the mounting pressure, the linkage protrusion (21) is driven to retract in the direction towards the interior of the groove (11) of the holder body (1) by bending deformation of the elastic connecting piece (22) under force.

6. The contact holder according to claim 3, wherein the linkage member (2) comprises a linkage protrusion (21) and an elastic connecting piece (22), and the linkage protrusion (21) is elastically connected to the holder body (1) through the elastic connecting piece and corresponds to the groove (11); in case that the linkage member (2) is subjected to the mounting pressure, the linkage protrusion (21) is driven to retract in the direction towards the interior of the groove (11) of the holder body (1) by bending deformation of the elastic connecting piece (22) under force.

7. The contact holder according to claim 4, wherein one end of the elastic connecting piece (22) is connected to the holder body (1), and another end of the elastic connecting piece (22) is suspended, the elastic connecting piece (22) corresponds to the groove (11); and the linkage protrusion (21) is disposed at the suspended end of the elastic connecting piece (22).

8. The contact holder according to claim 7, wherein the elastic connecting piece (22) has an elongated structure, with one end connected to an upper end of a side wall of the groove (11), and another end disposed in a suspended manner; and the elastic connecting piece (22) is flush with a surface of the groove (11).

9. The contact holder according to claim 4, wherein the elastic connecting piece (22) comprises a middle platform portion (221), and each of two ends of the middle platform portion (221) is connected to the holder body (1) through a U-shaped bent portion (222) and correspond to the groove (11); and the linkage protrusion (21) is fixedly connected to the middle platform portion (221).

10. The contact holder according to claim 9, wherein an opening of each U-shaped bent portion (222) is oriented towards a direction of a bottom surface of the groove (11), and a top of each U-shaped bent portion (222) is slightly higher than the middle platform portion (221).

11. An auxiliary contact module, comprising:
a housing (3),
a contact holder movably disposed inside the housing (3), comprising a holder body (1) and a linkage member (2) on the holder body (1), wherein the holder body (1) is provided with a groove (11) corresponding to the linkage member (2), and the linkage member (2) is of an elastically deformable structure, to allow the linkage member (2) to retract and deform in a direction towards an interior of the groove (11) when subjected to a mounting pressure; and
an auxiliary contact assembly mounted on the contact holder,
wherein the housing (3) is provided with an elongated avoidance hole (31) corresponding to a linkage member (2) of the contact holder and configured for partial exposure of the linkage member (2).

12. The auxiliary contact module according to claim 11, wherein the linkage member (2) is configured to be connected to an acting member inside a contactor body (4), and the linkage member (2) is of an elastically deformable structure capable of being bent, retracted and deformed in a mounting direction.

13. The auxiliary contact module according to claim 11, wherein the groove (11) is located in a middle position of the holder body (1), and the linkage (2) is connected to the holder body (1) and disposed corresponding to the groove (11).

14. The auxiliary contact module according to claim 11, wherein the linkage member (2) comprises a linkage protrusion (21) and an elastic connecting piece (22), and the linkage protrusion (21) is elastically connected to the holder body (1) through the elastic connecting piece and corresponds to the groove (11); in case that the linkage member (2) is subjected to the mounting pressure, the linkage protrusion (21) is driven to retract in the direction towards the interior of the groove (11) of the holder body (1) by bending deformation of the elastic connecting piece (22) under force.

15. The auxiliary contact module according to claim 14, wherein one end of the elastic connecting piece (22) is connected to the holder body (1), and another end of the elastic connecting piece (22) is suspended, the elastic connecting piece (22) corresponds to the groove (11); and the linkage protrusion (21) is disposed at the suspended end of the elastic connecting piece (22).

16. The auxiliary contact module according to claim 15, wherein the elastic connecting piece (22) has an elongated structure, with one end connected to an upper end of a side wall of the groove (11), and another end disposed in a suspended manner; and the elastic connecting piece (22) is flush with a surface of the groove (11).

17. The auxiliary contact module according to claim 14, wherein the elastic connecting piece (22) comprises a middle platform portion (221), and each of two ends of the middle platform portion (221) is connected to the holder body (1) through a U-shaped bent portion (222) and correspond to the groove (11); and the linkage protrusion (21) is fixedly connected to the middle platform portion (221).

18. The auxiliary contact module according to claim 17, wherein an opening of each U-shaped bent portion (222) is oriented towards a direction of a bottom surface of the groove (11), and a top of each U-shaped bent portion (222) is slightly higher than the middle platform portion (221).

19. A contactor, comprising a contactor body (4) and the auxiliary contact module according to claim 11, wherein a positioning protrusion (32) is provided in a middle of a lower end of the housing (3), a first snap (33) is provided at each of two sides of an upper end of the housing (3), and a movable second snap (34) is provided in a middle of the upper end; the auxiliary contact module and the contactor body (4) are fixedly connected together by using a positioning fit between the first positioning protrusion (32) and a side wall of the contactor body (4), as well as a snap fit between the first snap (33) and the second snap (34), and the side wall of the contactor body (4).
